(19) United States
(12) Patent Application Publication
(10) Pub. No.: US 2011/0255645 A1
(43) Pub. Date: Oct. 20, 2011

(54) Method for Producing Heavy Electrons

(75) Inventor: Joseph M. Zawodny, Poquoson, VA (US)

(73) Assignee: USA as represented by the Administrator of the National Aeronautics and Space Administration, Washington, DC (US)

(21) Appl. No.: 13/070,552

(22) Filed: Mar. 24, 2011

Related U.S. Application Data
(60) Provisional application No. 61/317,379, filed on Mar. 25, 2010.

(51) Int. Cl. G21B 1/00

(52) U.S. Cl. 376/108

(57) ABSTRACT

A method for producing heavy electrons is based on a material system that includes an electrically-conductive material is selected. The material system has a resonant frequency associated therewith for a given operational environment. A structure is formed that includes a non-electrically-conductive material and the material system. The structure incorporates the electrically-conductive material at least at a surface thereof. The geometry of the structure supports propagation of surface plasmon polaritons at a selected frequency that is approximately equal to the resonant frequency of the material system. As a result, heavy electrons are produced at the electrically-conductive material as the surface plasmon polaritons propagate along the structure.

### CROSS-REFERENCE TO RELATED PATENT APPLICATIONS

Pursuant to 35 U.S.C. §119, the benefit of priority from U.S. Provisional Patent Application Ser. No. 61/317,379, with a tiling date of Mar. 25, 2010, is claimed for this non-provisional application, the contents of which are hereby incorporated by reference in their entirety.

### STATEMENT REGARDING FEDERALLY SPONSORED RESEARCH OR DEVELOPMENT

The invention was made by an employee of the United States Government and may be manufactured and used by or for the Government of the United States of America for governmental purposes without the payment of any royalties thereon or therefor.

### BACKGROUND OF THE INVENTION

1. Field of the Invention

This invention relates to the production of heavy electrons. More specifically, the invention is a method of making a device, the device itself device, and a system using the device to produce heavy electrons via the sustained propagation of surface plasmon polaritons at a selected frequency.

2. Description of the Related Art

Heavy electrons exhibit properties such as unconventional superconductivity, weak antiferromagnetism, and pseudo metamagnetism. More recently, the energy associated with “low energy nuclear reactions” (LENR) has been linked to the production of heavy electrons. Briefly, this theory put forth by Widom and Larsen states that the initiation of LENR activity is due to the coupling of “surface plasmon polaritons” (SPPs) to a proton or deuteron resonance in the lattice of a metal hydride. The theory goes on to describe the production of heavy electron that undergo electron capture by a proton. This activity produces a neutron that is subsequently captured by a nearby atom transmuting it into a new element and releasing positive net energy in the process. See A. Windom et al. “Ultra Low Momentum Neutron Catalyzed Nuclear Reactions on Metallic Hydride Surface,” European Physical Journal C-Particles and Fields, 46, pp. 107-112, 2006, and U.S. Pat. No. 7,893,414 issued to Larsen et al. Unfortunately, such heavy electron production has only occurred in small random regions or patches of sample materials/devices. In terms of energy generation or gamma ray shielding, this limits the predictability and effectiveness of the device. Further, random-patch heavy electron production limits the amount of positive net energy that is produced to limit the efficiency of the device in an energy generation application.

### SUMMARY OF THE INVENTION

Accordingly, it is an object of the present invention to provide a method of making a device that produces heavy electrons. A method of producing heavy electrons is also disclosed. The steps may include selecting a material system that includes an electrically-conductive material. The material system may have a resonant frequency associated therewith for a given operational environment. The step may further include forming a structure having a surface. The structure may comprise a non-electrically-conductive material and the material system. The structure may incorporate the electrically-conductive material at least at the surface of the structure. Geometry of the structure supports propagation of surface plasmon polaritons at a selected frequency that is approximately equal to the resonant frequency of the material system. The step may further include producing heavy electrons at the electrically-conductive material as the surface plasmon polaritons propagate along the structure. The steps may also include applying energy to a portion of the structure to induce propagation of the surface plasmon polaritons at the portion. The material system may comprise a metal hydride. The electrically-conductive material may be in a form selected from the group consisting of particles and whiskers. The structure may include a solid matrix material with the electrically-conductive material mixed therein. The structure may exist in a state selected from the group consisting of a gas, a liquid, and a plasma. The electrically-conductive material may be mixed in the structure. The structure may comprise a two-dimensional structure or a three-dimensional structure. The geometry may also comprise a fractal geometry. The step of applying further may further comprise the step of impinging the structure with a form of energy selected from the group consisting of electric energy, thermal energy, photonic energy, energy associated with an ion beam, and energy associated with a flow of gas. The step of applying may further comprise the step of altering the geometry of the structure at the portion thereof.

Another object of the present invention is to provide a method of making a device that produces heavy electrons. The method may comprise selecting a metal hydride having a resonant frequency associated therewith for a given operational environment. The method may also comprise forming a structure that includes a non-electrically-conductive material and the metal hydride. The structure may incorporate the metal hydride at least at a surface of the structure. The geometry of the structure may supports propagation of surface plasmon polaritons at a selected frequency that is approximately equal to the resonant frequency of the metal hydride. The method may also include applying energy to a portion of the structure to induce propagation of the surface plasmon polaritons at the portion. The heavy electrons may be produced at the metal hydride as the surface plasmon polaritons propagate along the structure. The metal hydride may comprise particles or whiskers. The structure can include a solid matrix material with the metal hydride mixed therein. The geometry may also comprise fractal geometry. The structure may exist in a state selected from the group consisting of a gas, a liquid. and a plasma. The metal hydride may be mixed in the structure. The structure may comprise a two-dimensional structure or a three-dimensional structure. The method of applying may also include the step of impinging the structure with a form of energy selected from the group consisting of electric energy, thermal energy, photonic energy, energy associated with an ion beam, and energy associated with a flow of gas. The step of applying may also comprise the step of altering the geometry of the structure at the portion thereof.

Yet another object of the present invention is a method for selective enhancement of surface plasmon polaritons to initiate and sustain low energy number reaction in metal or metal hydride systems. The method includes providing a material system comprising an electrically-conductive material. The material system may have a resonant frequency associated therewith for a given operational environment. The method also includes forming a structure having a surface. The structure may comprise a non-electrically-conductive material and the material system. The structure may incorporate the electrically-conductive material at least at the surface of the structure. The geometry of the structure can support propagation of surface plasmon polaritons at a selected frequency that is approximately equal to the resonant frequency of the material system. The method can further include producing heavy electrons at the electrically-conductive material as the surface plasmon polaritons propagate along the structure. The electrically-conductive material can comprise particles or whiskers, and the electrically-conductive material may be chosen from the group consisting of metal or metal hydride.

Another object of the present invention is to provide a device that produces heavy electrons. The device may comprise a non-electrically-conductive material, and a material system that includes an electrically-conductive material. The material system may have a resonant frequency associated therewith for a given operational environment. The device may also comprise a structure that includes the non-electrically-conductive material and the material system. The structure may incorporate the electrically-conductive material at least at a surface of the structure. The geometry of the structure may support propagation of surface plasmon polaritons at a selected frequency that is approximately equal to the resonant frequency of the material system. The heavy electrons may be produced at the electrically-conductive material as the surface plasmon polaritons propagate along the structure.

Still another object of the present invention is to provide a system that produces heavy electrons. The system may comprise a non-electrically-conductive material and a material system that includes an electrically-conductive material. The material system can have a resonant frequency associated therewith for a given operational environment. The system can also comprise a structure that includes the non-electrically-conductive material and the material system. The structure can incorporate the electrically-conductive material at least at a surface of the structure. The geometry of the structure can support propagation of surface plasmon polaritons at a selected frequency that is approximately equal to the resonant frequency of the material system. The system may also comprise a source for applying energy to a portion of the structure to induce propagation of the surface plasmon polaritons at the portion. The heavy electrons may be produced at the electrically-conductive material as the surface plasmon polaritons propagate along the structure. The source can impinge the structure with a form of energy selected from the group consisting of electric energy, thermal energy, photonic energy, energy associated with an ion beam, and energy associated with a flow of gas. The source can alter the geometry of the structure at the portion thereof.

Yet another object of the present invention is to provide a device and system that produces heavy electrons all across and/or throughout a material structure.

In accordance with the present invention, a method of making a device that produces heavy electrons is provided as well as the device itself. A material system that includes an electrically-conductive material is selected. The material system has a resonant frequency associated therewith for a given operational environment. A structure is formed that includes a non-electrically-conductive material and the material system. The structure incorporates the electrically-conductive material at least at a surface thereof. The geometry of the structure is one that supports propagation of surface plasmon polaritons at a selected frequency that is approximately equal to the resonant frequency of the material system. As a result, heavy electrons are produced at the electrically-conductive material as the surface plasmon polaritons propagate along the structure. Energy can be applied to a portion of the structure to induce propagation of the surface plasmon polaritons. The source of the energy combined with the device form a system for producing heavy electrons.

### BRIEF DESCRIPTION OF THE DRAWINGS

FIG. 1 is a schematic view of a device for producing heavy electrons in accordance with an embodiment of the present invention;

FIG. 2 is a cross-sectional view of a device for producing heavy electrons in accordance with an embodiment of the present invention;

FIG. 3 is a cross-sectional view of a device for producing heavy electrons in accordance with an embodiment of the present invention;

FIG. 4 is a schematic view of a system for producing heavy electrons in accordance with an embodiment of the present invention; and

FIG. 5 is a schematic view of a system for producing heavy electrons in accordance with another embodiment of the present invention.

### DETAILED DESCRIPTION OF THE INVENTION

The present invention is a method for making a device that can produce heavy electrons where such heavy electron production can be used in a variety of applications that includes energy generation. In addition, the present invention is the device made from the disclosed method as well as a system that uses the device to produce heavy electrons. The present invention allows an entire device surface or volume to produce heavy electrons as opposed such production in small random regions of materials/devices. Thus, devices/systems constructed in accordance with the present invention will have performance that is predictable and maximize heavy electron production that results in, for example, maximum energy production for a given device/system or predictable efficiency and effectiveness of a gamma ray shield.

As mentioned above, U.S. Pat. No. 7,893,414 issued to Larsen et al. discloses the general relationship link between “surface plasmon polaritons” (SPPs) on a metal hydride's surface and the resulting heavy electron production at random regions or patches of the surface. Accordingly, U.S. Pat. No. 7,893,414 is incorporated by reference in its entirety.

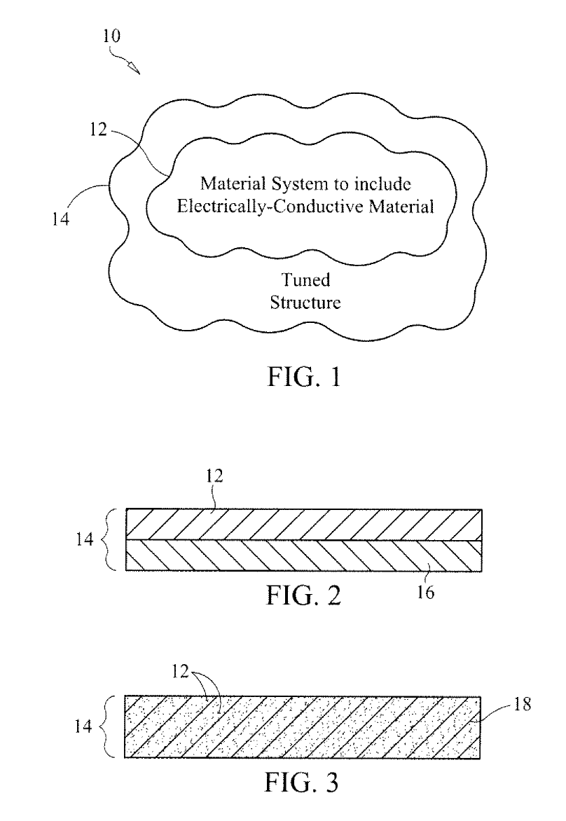

Referring now to the drawings and more particularly to FIG. 1, a device for producing heavy electrons in accordance with the present invention is shown and is referenced generally by numeral 10. The present invention provides a method of making devices that can produce heavy electrons in a predictable/controllable fashion across an entire surface or volume of the device. In general, device 10 includes a selected material system 12 that is incorporated onto/into a tuned structure 14 that supports propagation of SPPs and resulting heavy electron production that is sustained by device 10 across and/or through the entirety thereof. Material system 12 includes an electrically-conductive material (e.g., metal, carbon nanotubes, graphene, superconducting materials, etc.), while tuned structure 14 includes a non-electrically-conductive material that supports and incorporates material system 12 with the electrically-conductive material being present at least at a surface of device 10. The physical state and geometry of tuned structure 14 incorporating material system 12 can be adapted for a variety of applications while satisfying sustained heavy electron production. For example, the physical state could be a solid, liquid, gas, or plasma, without departing from the scope of the present invention. The geometry could be two-dimensional or sheet-like, three-dimensional, or fractal without departing from the scope of the present invention.

Regardless of its physical state/geometry, device 10 is made in such a way that it will establish a resonance in a SPP (e.g., via its inherent thermal energy for a given working environment, or via the application of energy to initiate SPP resonance) at a small region or portion of device 10. Device 10 is constructed so that the energy associated with the SPP resonance is constrained to the SPP resonant frequency as the SPP travels along the surface of device 10 where the electrically-conductive material (in material system 12) is present. As a result, the amplitude of the SPP at the SPP resonant frequency is significantly enhanced as it propagates when compared to an unstructured device operating in otherwise identical conditions. This enhancement comes at the expense of the SPP amplitudes at frequencies away from the SPP resonant frequency such that the total integral of the energy from SPP at all frequencies is conserved. The amplitude enhancement at the SPP resonant frequency assures sustained SPP propagation and resulting heavy electron production. These results are achieved by making device 10 in accordance with the following process described below.

A particular material system 12 is selected for a particular application where the application might dictate that device 10 be formed as a sheet (e.g., a power source for smaller electronics), a block (e.g., fuel cell), or a flowing fluid (e.g., rocket propulsion). Regardless of the application, material system 12 will have a resonant frequency associated therewith for the working or operating environment of the application. Determination of this resonant frequency can be achieved by experimentation as would be understood in the art. For example, the resonant frequency for metal hydride systems can be measured using neutron scattering. The resonant frequency for molecules (e.g., molecular films such as polycyclic aromatic hydrocarbons or PAHs, hydrogenated/deuterated molecular structures such as graphane and its nanotube variants) can be determined for specific vibrational or rotational modes using spectroscopy.

As mentioned above, material system 12 includes an electrically-conductive material. Material system 12 also includes protons or deuterons in contact with the electrically-conductive material such that heavy electrons are produced as SPPs propagate therealong. Accordingly, examples of material system 12 include metal hydrides, molecular films on electrical conductors, and graphene and its nanotube variants.

With material system 12 being so-selected and its resonant frequency for a working environment being determined/known, tuned structure 14 incorporating material system 12 is formed. In accordance with the present invention, this is achieved by making the geometry of structure 14/material system 12 such that the SPP resonance thereof is established (i.e., either by inherent thermal energy of device 10 or application of energy thereto that initiates SPP resonance) at a frequency (i.e., the SPP resonant frequency) that is approximately equal to the above-described resonant frequency of material system 12. The establishment of the SPP resonance can occur at a small region or portion of device 10. The corresponding heat/energy associated with the SPP resonance serves as feedback into device 10. As a result, the SPP resonance is positively reinforced and sustained throughout device 10 for resulting sustained heavy electron production. That is, once established, SPP resonance will be self-sustaining so that large power output-to-input ratios will be possible from device 10.

Incorporation of material system 12 with tuned structure 14 can be achieved in a variety of ways without departing from the scope of the present invention. For example, FIG. 2 illustrates a laminate construction where material system 12 is supported on a substrate 16 to form tuned structure 14. FIG. 3 illustrates another embodiment of tuned structure 14 where material system 12 is in the form of particles or whiskers that are mixed in a matrix 18 that can be solid, liquid, gas, or plasma, without departing from the scope of the present invention. It is to be understood that the rectangular geometries used in FIGS. 2 and 3 are only for purpose of illustration and comprise an embodiment of the present invention.

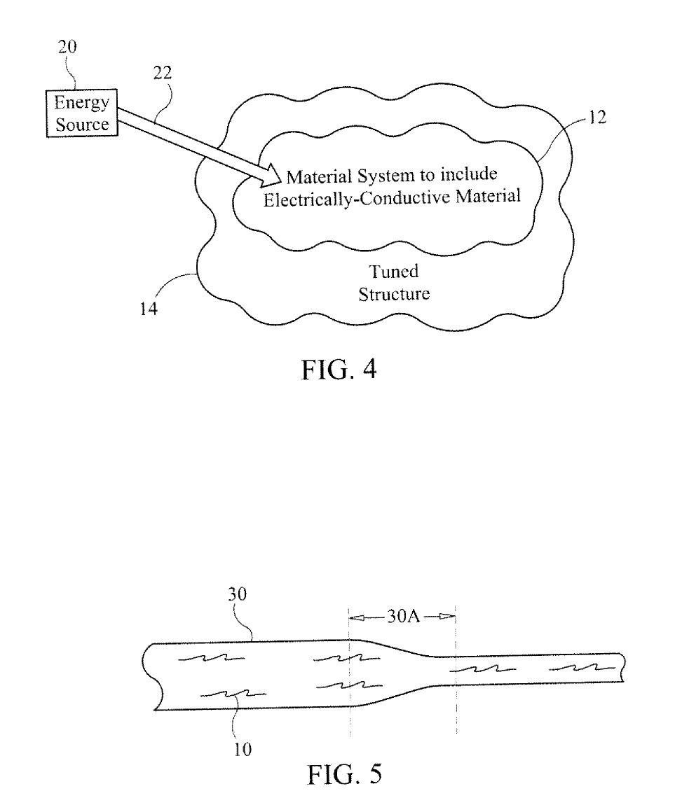

Establishment of the SPP resonance at or near the resonant frequency of material system 12 can occur as the result of the working environment of device 10 (e.g., the operating pressures, temperatures, etc.). Establishment of the SPP resonance can also be initiated by the application of energy to at least a portion of device 10. For example, FIG. 4 illustrates a system of the present invention where an energy source 20 generates energy 22 that will be applied to device 10. Energy 22 could be electric, thermal or photonic. Energy 22 could also be from an ion beam or a flow of gas. The application of energy to device 10 could also be achieved by controlling the mass flow rate and/or geometry of device 10 when it is in a fluid, gas, or plasma state. Accordingly, FIG. 5 illustrates another system that includes a conduit 30 with a changing geometry region 30A. In general, region 30A is designed to effectively apply energy to device 10 to control/establish the geometry/structure for the SPP resonance to thereby initiate the SPP resonance at the resonant frequency of the material system used in device 10.

The above-described tuned structure 14 incorporating material system 12 can exist as particles, in two-dimensional geometries, three-dimensional geometries, and even fractal geometries. Several non-limiting examples will be discussed below.

Individual particles, by themselves, are the simplest embodiment of a material system used by the present invention. Spherical or nearly spherical particles naturally resonate at a frequency where the particle circumference is equal to a multiple of the SPP wavelength. Similarly, long and thin, needle-like particles or whiskers can resonate in modes analogous to small antenna when the length of the particle is an integer multiple of one-half the SPP wavelength.

Two-dimensional embodiments are comprised of periodic textures or arrayed structures that, by design, resonate at specific SPP frequencies. Examples include triangular, rectangular, or hexagonal arrays of posts (e.g., cylinders, truncated cones, or derivatives of these with more complex, non-circular bases) where the array of objects creates and reinforces a natural SPP resonance at the desired frequency either in the array elements themselves or on the surface in the voids between array elements. The array elements can also be shaped depressions in a metal surface, such as bowls, polygonal-based cylindrical/conical holes, or more complex textures. The primary advantage of resonance of arrays of elements over individual particles is that the array geometry (pattern and spacing) amplifies the resonance of the individual elements through a mutual interaction (i.e., mutual inductance and/or mutual capacitance) of multiple similar elements or by establishing the resonance of otherwise non-resonant elements where the details of the array geometry itself creates or reinforces the desired resonance.

Three-dimensional embodiments are periodic arrays of elements in three-dimensional or volume-filling fractal forms of two-dimensional embodiments. Periodic arrays in three dimensions can take a variety of forms analogous to the two-dimensional case as can be seen in common materials such as the array of locations of atoms in various crystal forms, the locations of objects closely packed to minimize volume, or the quasi-crystalline arrays of particles found in dusty plasmas under certain conditions. The last example is useful in that the array can be formed within a moving and dynamic fluid. These fluid forms represent an important embodiment for use in high power devices. The array elements can themselves be, but are not required to be, resonant at the desired frequency. An example of an array of resonant elements would be a number of properly designed metallic whiskers oriented and spaced in a regular three-dimensional rectangular array within an inert supporting matrix such as a ceramic. Another example would be resonant metallic particles that were electrically charged and self organized into a quasi-crystalline array within a dusty plasma. The geometry of this fluid crystal comprised of dusty plasma could be controlled by adjusting the rate of mass flow through a device or by altering the geometry of the tube, body, or orifice through/over which the dusty plasmas flows (i.e., the resultant changes in pressure and/or temperature would be used to provide the SPP excitation). In both of these cases, it is the combination of the resonant elements coupling to (and reinforced by) the resonance of the overall array geometry that produces the desired effect. For arrays of non-resonant elements, the geometry of the array is critical in establishing the desired SPP resonance. Arrays of non-resonant elements are usually limited to two-dimensional surface or three-dimensional fractal embodiments because the required geometry must be tightly established and controlled.

The advantages of the present invention are numerous. Devices/systems made in accordance with the present invention control the frequency of the SPP resonance and its uniformity over large surface or volume regions. This will allow an entire device to participate in heavy electron production and ensuing energy generation. The present invention is adaptable to a variety of physical states/geometries and is scalable in size thereby making it available for energy production in a wide variety of applications (e.g., hand-held and large scale electronics, automobiles, aircraft, surface ships, electric power generation, rockets, etc.)

While preferred embodiments and example configurations of the invention have been herein illustrated, shown and described, it is to be appreciated that various changes, rearrangements and modifications may be made therein, without departing from the scope of the invention as defined by the appended claims. It is intended that the specific embodiments and configurations disclosed are illustrative of the preferred and best modes for practicing the invention, and should not be interpreted as limitations on the scope of the invention as defined by the appended claims and it is to be appreciated that various changes, rearrangements and modifications may be made therein, without departing from the scope of the invention as defined by the appended claims.

What is claimed as new and desired to be secured by Letters Patent of the United States is:

1. A method of producing heavy electrons, comprising the steps of:
selecting a material system that includes an electrically-conductive material, said material system having a resonant frequency associated therewith for a given operational environment; and
forming a structure having a surface, said structure comprising a non-electrically-conductive material and said material system, said structure incorporating said electrically-conductive material at least at said surface of said structure, wherein a geometry of said structure supports propagation of surface plasmon polaritons at a selected frequency that is approximately equal to said resonant frequency of said material system, and
producing heavy electrons at said electrically-conductive material as said surface plasmon polaritons propagate along said structure.

2. The method according to claim 1, further comprising the step of applying energy to a portion of said structure to induce propagation of said surface plasmon polaritons at said portion.

3. The method according to claim 1, wherein said material system comprises a metal hydride.

4. The method according to claim 1, wherein said electrically-conductive material is in a form selected from the group consisting of particles and whiskers.

5. The method according to claim 4, wherein said structure includes a solid matrix material with said electrically-conductive material mixed therein.

6. The method according to claim 4, wherein said structure exists in a state selected from the group consisting of a gas, a liquid, and a plasma, and wherein said electrically-conductive material is mixed in said structure.

7. The method according to claim 1, wherein said structure comprises a two-dimensional structure.

8. The method according to claim 1, wherein said structure comprises a three-dimensional structure.

9. The method according to claim 1, wherein said geometry comprises a fractal geometry.

10. The method according to claim 2, wherein said step of applying further comprises the step of impinging said structure with a form of energy selected from the group consisting of electric energy, thermal energy, photonic energy, energy associated with an ion beam, and energy associated with a flow of gas.

11. The method according to claim 2, wherein said step of applying further comprises the step of altering said geometry of said structure at said portion thereof.

12. A method of making a device that produces heavy electrons, comprising the steps of:
selecting a metal hydride having a resonant frequency associated therewith for a given operational environment;
forming a structure that includes a non-electrically-conductive material and said metal hydride, said structure incorporating said metal hydride at least at a surface of said structure, wherein a geometry of said structure supports propagation of surface plasmon polaritons at a selected frequency that is approximately equal to said resonant frequency of said metal hydride; and
applying energy to a portion of said structure to induce propagation of said surface plasmon polaritons at said portion, wherein heavy electrons are produced at said metal hydride as said surface plasmon polaritons propagate along said structure.

13. The method according to claim 12, wherein said metal hydride comprises particles or whiskers.

14. The method according to claim 13, wherein said structure includes a solid matrix material with said metal hydride mixed therein, and wherein said geometry comprises fractal geometry.

15. The method according to claim 13, wherein said structure exists in a state selected from the group consisting of a gas, a liquid, and a plasma, and wherein said metal hydride is mixed in said structure.

16. The method according to claim 12, wherein said structure comprises a two-dimensional structure or a three-dimensional structure.

17. The method according to claim 12, wherein said step of applying comprises the step of impinging said structure with a form of energy selected from the group consisting of electric energy, thermal energy, photonic energy, energy associated with an ion beam, and energy associated with a flow of gas.

18. The method according to claim 12, wherein said step of applying comprises the step of altering said geometry of said structure at said portion thereof.

19. A method for selective enhancement of surface plasmon polaritons to initiate and sustain low energy number reaction in material systems, comprising the steps of:
providing a material system comprising an electrically-conductive material, said material system having a resonant frequency associated therewith for a given operational environment; and
forming a structure having a surface, said structure comprising a non-electrically-conductive material and said material system, said structure incorporating said electrically-conductive material at least at said surface of said structure, wherein a geometry of said structure supports propagation of surface plasmon polaritons at a selected frequency that is approximately equal to said resonant frequency of said material system, and
applying energy to a portion of said structure to induce propagation of said surface plasmon polaritons at said portion, wherein heavy electrons are produced at said material system as said surface plasmon polaritons propagate along said structure.

20. The method according to claim 19, wherein the electrically-conductive material comprises particles or whiskers, and wherein said electrically-conductive material is chosen from the group consisting of metal or metal hydride.
